(19) United States
(12) Patent Application Publication
(10) Pub. No.: US 2024/0381164 A1
(43) Pub. Date: Nov. 14, 2024

(54) SERVICE DATA PACKET PROCESSING METHOD AND APPARATUS, MEDIUM, AND ELECTRONIC DEVICE

(71) Applicant: Tencent Technology (Shenzhen) Company Limited, Shenzhen (CN)

(72) Inventor: Yixue LEI, Shenzhen (CN)

(73) Assignee: Tencent Technology (Shenzhen) Company Limited, Shenzhen (CN)

(21) Appl. No.: 18/779,822

(22) Filed: Jul. 22, 2024

Related U.S. Application Data
(63) Continuation of application No. PCT/CN2023/089410, filed on Apr. 20, 2023.

(30) Foreign Application Priority Data
Jun. 28, 2022 (CN) 202210741295.2

(51) Int. Cl. H04W 28/02; H04W 28/06

(52) U.S. Cl. CPC H04W 28/0268; H04W 28/06

(57) ABSTRACT

A service data packet processing method, performed by a network-side network element, includes: receiving characteristic assistance data transmitted by an application-side network element for a service flow; performing characteristic parameter inferencing based on the characteristic assistance data to obtain a target characteristic parameter of the service flow; and processing a first service data packet of the service flow based on the obtained target characteristic parameter, wherein the characteristic assistance data includes data associated with a first characteristic of the service flow.

### CROSS-REFERENCE TO RELATED APPLICATIONS

This application is a continuation application of International Application No. PCT/CN2023/089410 filed on Apr. 20, 2023, which claims priority to Chinese Patent Application No. 202210741295.2, filed with the China National Intellectual Property Administration on Jun. 28, 2022, the disclosures of each being incorporated by reference herein in their entireties.

### FIELD

The disclosure relates to the field of computer and communication technologies, and specifically, to a service data packet processing method and apparatus, a medium, and an electronic device.

### BACKGROUND

In 5G and evolved 5G systems, high-bandwidth interactive services may be an important service type, for example, cloud gaming, virtual reality (VR), augmented reality (AR), mixed reality (MR), extended reality (XR), and cinematic reality (CR).

The high-bandwidth interactive services have high requirements for timeliness of transmission, and with improvement of indexes such as resolution, a frame rate, and a degree of freedom, a data volume generated by an application layer also significantly increases. Therefore, data packet content generated by application layers of the services may need to be split into a large number of data packets for segmented transmission at a very low delay. However, ensuring efficient processing of the data packets during segmented transmission is a technical problem that has not been adequately resolved.

### SUMMARY

Provided are a service data packet processing method and apparatus, a medium, and an electronic device.

According to some embodiments, a service data packet processing method, performed by a network-side network element, includes: receiving characteristic assistance data transmitted by an application-side network element for a service flow; performing characteristic parameter inferencing based on the characteristic assistance data to obtain a target characteristic parameter of the service flow; and processing a first service data packet of the service flow based on the obtained target characteristic parameter, wherein the characteristic assistance data includes data associated with a first characteristic of the service flow.

According some embodiments, a service data packet processing apparatus of a network-side network element includes: at least one memory configured to store program code; and at least one processor configured to read the program code and operate as instructed by the program code, the program code including: receiving code configured to cause at least one of the at least one processor to receive characteristic assistance data transmitted by an application-side network element for a service flow; inference code configured to cause at least one of the at least one processor to perform characteristic parameter inferencing based on the characteristic assistance data to obtain a target characteristic parameter of the service flow; and processing code configured to cause at least one of the at least one processor to process a first service data packet of the service flow based on the obtained target characteristic parameter, wherein the characteristic assistance data includes data associated with a first characteristic of the service flow.

According to some embodiments, a non-transitory computer-readable medium storing computer code which, when executed by at least one processor, causes the at least one processor to at least: receive characteristic assistance data transmitted by an application-side network element for a service flow; perform characteristic parameter inferencing based on the characteristic assistance data to obtain a target characteristic parameter of the service flow; and process a first service data packet of the service flow based on the obtained target characteristic parameter, wherein the characteristic assistance data includes data associated with a first characteristic of the service flow.

The foregoing and following descriptions are merely exemplary and explanatory, and the disclosure is not limited thereto.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture according to some embodiments.

FIG. 2 is a schematic diagram of a transmission process of a multimedia data packet according to some embodiments.

FIG. 3 is a flowchart of a service data packet processing method according to some embodiments.

FIG. 4 is a flowchart of a service data packet processing method according to some embodiments.

FIG. 5 is a flowchart of a service data packet processing method according to some embodiments.

FIG. 6 is a flowchart of a service data packet processing method according to some embodiments.

FIG. 7 is a block diagram of a service data packet processing apparatus according to some embodiments.

FIG. 8 is a block diagram of a service data packet processing apparatus according to some embodiments.

FIG. 9 is a schematic structural diagram of a computer system of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The block diagrams shown in the accompanying drawings may be functional entities, and do not necessarily correspond to physically independent entities. The functional entities may be implemented in a software form, or implemented in one or more hardware modules or integrated circuits, or implemented in different networks and/or processor apparatuses and/or microcontroller apparatuses.

The flowcharts shown in the accompanying drawings are exemplary descriptions, do not need to include all content and operations, and do not need to be performed in the described orders either. For example, some operations may be further divided, and some operations may be combined or partially combined. An actual execution order may change based on an actual case.

“Plurality of” means two or more. “And/or” describes an association relationship of associated objects, indicating that three relationships may exist. For example, A and/or B may indicate the following three cases: Only A exists, both A and B exist, and only B exists. The character “/” may indicate an “or” relationship between the associated objects.

With development of fifth generation mobile communication technology (5G), many multimedia services using more data volumes and short delays are applied. For example, interactive services such as a cloud gaming service, VR, AR, MR, XR, and CR are applied.

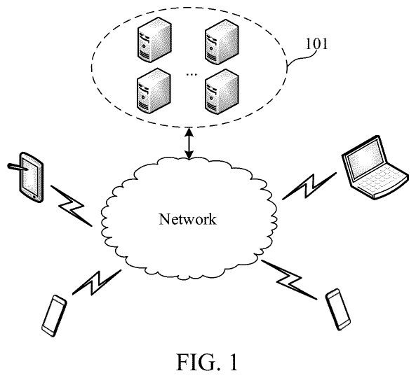

For example, in a cloud gaming scenario shown in FIG. 1, a cloud server 101 may be configured to run a cloud game. The cloud server 101 may render a game picture, perform encoding processing on an audio signal and a rendered image, and finally transmit encoded data obtained through encoding processing to each game client through a network. A game client may be user equipment (UE) with a streaming media playback capability, a human-computer interaction capability, a communication capability, and the like, such as a smart phone, a tablet computer, a notebook computer, a desktop computer, a smart television, a smart home, an in-vehicle terminal, or an aircraft; or the game client may be an application program running in a terminal device. The game client may decode the encoded data transmitted by the cloud server 101 to obtain analog audio and video signals and play the analog audio and video signals.

FIG. 1 is an exemplary system architecture representing a cloud gaming system according to some embodiments, and does not limit an architecture of the cloud gaming system. For example, in some embodiments, the cloud gaming system may further include a back-end server for scheduling, or the like. In addition, the cloud server 101 may be an independent physical server, or may be a server cluster formed by a plurality of physical servers or a distributed system, or may be a cloud server providing cloud computing services, for example, a cloud service, a cloud database, cloud computing, a cloud function, cloud storage, a network service, cloud communication, a middleware service, a domain name service, a security service, a content delivery network (CDN), and a big data and artificial intelligence platform. The game client and the cloud server 101 may be directly or indirectly connected in a wired or wireless communication manner.

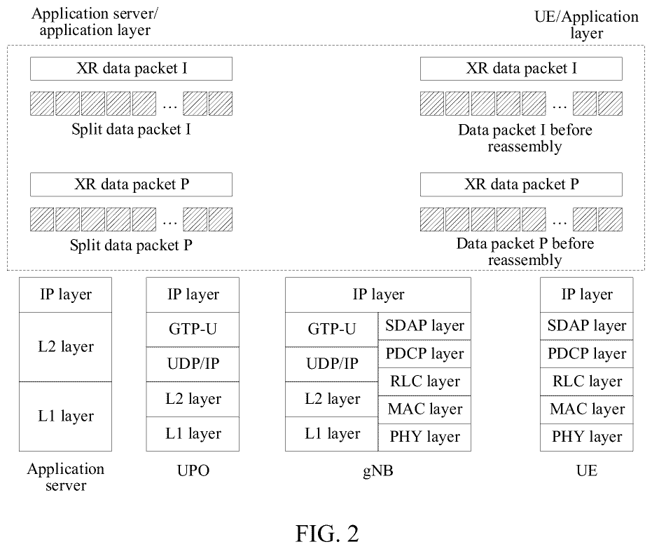

In various multimedia-based interactive service application scenarios, because a multimedia data packet is huge, during transmission, a plurality of data packets may be split for transmission. As shown in FIG. 2, in a 5G system, a user plane may includes an application server, a user plane object (UPO) (or sometimes referred to as a “user plane function” (UPF) by the 3rd Generation Partnership Project (3GPP), for example), a next generation node (gNB), and user equipment (UE). Transmission of the multimedia data packet may be in a downlink direction for some service scenarios. For example, the multimedia data packet is transmitted from the application server to the UPO, and then transmitted to the UE through the gNB. During transmission, the multimedia data packet (using an XR data packet as an example in FIG. 2) is split at an application layer of the application server. Based on a split data packet being used as an IP packet to reach the UPO from the application server, the 5G system transmits sub-data packets to a UE end through a protocol data unit (PDU) session, and at the UE end, the sub-data packets are submitted upward from a protocol stack and reassembled to recover the multimedia data packet. Because a data packet is generated in a service scenario, the data packet may be referred to as a service data packet.

In the system shown in FIG. 2, an L1 layer refers to a physical layer, and may be configured to ensure that original data may be transmitted over various physical media; an L2 layer refers to a data link layer, and the data link layer provides services for a network layer based on services provided by the physical layer; and an Internet protocol (IP) layer is the network layer, and may be configured to implement data transmission between two end systems; UDP stands for a user datagram protocol; GTP-U stands for a general packet radio service (GPRS) tunneling protocol; PHY stands for physical; MAC stands for media access control; RLC stands for radio link control; PDCP stands for a packet data convergence protocol; and SDAP stands for a service data adaptation protocol.

As described above, for the multimedia services, one frame of the multimedia data packet may be divided into a plurality of data packets for transmission. However, if the data packets are transmitted in a network, the network may not distinguish an association relationship between the data packets and may not refer to the association relationship based on a packet being lost during network congestion. In addition, it is unclear whether the data packets are of equal ranking and whether some data packets are recoverable after being lost, and the like, and lack of such information leads to blindness in processing received data packets by a network-side network element.

For example, if some data packets are lost, a frame, a group of pictures (GoP), or other video content may not be able to be decoded. Remaining data packets may also be discarded. On the contrary, if the received data packets relied on for recovery based on some data packets being discarded, the received data packets may not be discarded. In addition, periodicities exist in some XR and media services (XRM) service flows. Based on the periodicities, a wireless network may improve time-frequency resource efficiency during scheduling and transmission, for example, based on periodicities of XRM services, a semi-persistent scheduling (SPS) or connected-discontinuous reception (C-DRX) mechanism is used.

The characteristic parameter may be provided by an application-side network element to the network-side network element to cause the network-side network element to obtain a characteristic parameter of a service flow. However, this manner may have a high requirement for the application-side network element. For example, the application-side network element may be capable of providing whether a periodicity exists in a characteristic of the service flow, whether a correlation exists between service data packets, and the like. However, in actual deployment, it may be difficult for the application-side network element to fully provide such information. The application-side network element may not be relied upon to provide the characteristic of the service flow, but this design may depend on the network-side network element for inference and may have some blindness and inaccuracy. In addition, continuously performing characteristic guessing on the service flow may also cause an increase in a network-side processing algorithm. For example, if such an inference mechanism is run at a gateway node such as the UPO of a 5G network, a load of the gateway node is increased, and may affect a throughput, operation efficiency, and the like of the 5G network system.

Some embodiments provide a new service data packet processing method, so that an application-side network element may provide a part of characteristic parameters of a service flow to a network-side network element, and the network-side network element infers, based on an indication of the part of characteristic parameters, remaining characteristic parameters through an artificial intelligence (AI) method, to implement processing of data of a multimedia service such as XR.

In some embodiments, the network-side network element may perform characteristic parameter inferencing by using a machine learning (ML) method in the AI.

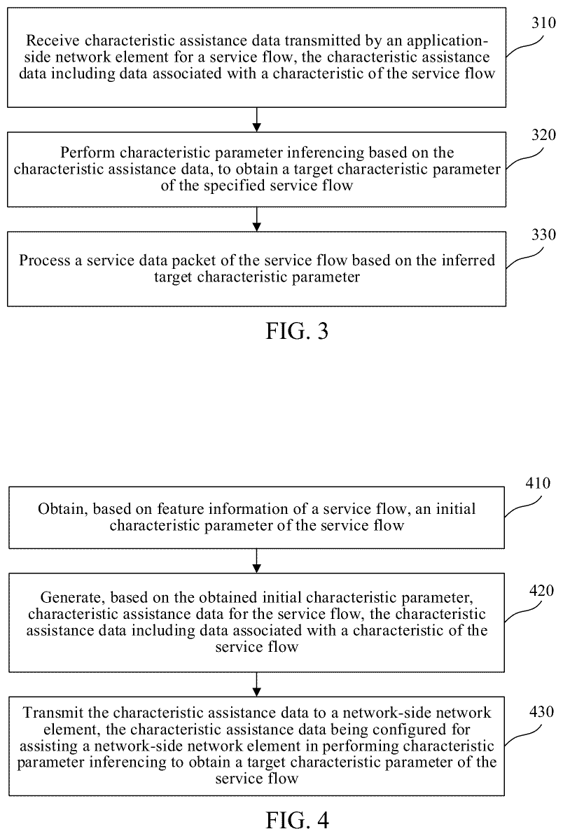

FIG. 3 is a flowchart of a service data packet processing method according to some embodiments. The service data packet processing method may be performed by a network-side network element, and the network-side network element may be, for example, a policy control object (PCO) (or sometimes referred to as a “policy control function” (PCF) by the 3GPP, for example). Refer to FIG. 3. The service data packet processing method may include operations 310 to 330. Detailed descriptions are as follows.

310: Receive characteristic assistance data transmitted by an application-side network element for a service flow, the characteristic assistance data including data associated with a characteristic of the service flow.

In some embodiments, the characteristic assistance data is used by the network-side network element to determine a characteristic parameter of the service flow, for example, may include a part of characteristic parameters of the service flow, or may include indication information configured for determining the characteristic parameter of the service flow.

The characteristic assistance data may be configured for indicating whether a periodicity exists in the service flow. If the periodicity exists, the characteristic assistance data may further include a value of the periodicity or an interval of the periodicity, or may further include whether data volumes transmitted in different periodicities are equal.

The characteristic assistance data may be configured for indicating whether a corresponding transmission rate exists in the service flow. If the transmission rate exists, the transmission rate may be a rate range, an average transmission rate, or the like.

The characteristic assistance data may be configured for indicating whether a constant frame rate exists in the service flow. If the constant frame rate exists, the characteristic assistance data may further include a value of the frame rate, an interval in which the frame rate is located, or the like.

The characteristic assistance data may be configured for indicating whether a constant key frame interval exists in the service flow. If the constant key frame interval exists, the characteristic assistance data may further include a value of the key frame interval, an interval in which the key frame interval is located, or the like.

The characteristic assistance data may be configured for indicating whether a service data packet set (for example, a PDU set) having an association exists in the service flow. If the PDU set exists, the characteristic assistance data may further include whether service data packets in the PDU set are of equal ranking, whether content corresponding to the PDU set is recoverable after part of the service data packets in the PDU set are lost, and the like.

FIG. 3, 320: Perform characteristic parameter inferencing based on the characteristic assistance data to obtain a target characteristic parameter of the service flow.

The target characteristic parameter may be a complete characteristic parameter for processing a service data packet. All characteristic parameters and corresponding values may be included. In some embodiments, the target characteristic parameter of the service flow obtained through inference based on the characteristic assistance data may include a periodicity of a service data packet corresponding to the service flow. For example, the characteristic assistance data indicates whether the periodicity exists in the service flow. If the characteristic assistance data indicates that the periodicity exists, the value of the periodicity or the interval in which the periodicity is located may be further obtained through inference. Whether the data volumes transmitted in the different periodicities are equal may be further obtained through inference.

In some embodiments, the target characteristic parameter of the service flow obtained through inference based on the characteristic assistance data may include a transmission rate of the service data packet corresponding to the service flow. For example, the characteristic assistance data indicates whether the transmission rate exists in the service flow. If the characteristic assistance data indicates that the transmission rate exists, the rate range of the transmission rate, the average transmission rate, or the like may be further obtained through inference.

In some embodiments, the target characteristic parameter of the service flow obtained through inference based on the characteristic assistance data may include a frame rate of a service data packet corresponding to the service flow. For example, the characteristic assistance data indicates whether the constant frame rate exists in the service flow. If the characteristic assistance data indicates that the constant frame rate exists, the value of the frame rate, the interval in which the frame rate is located, or the like may be further obtained through inference.

In some embodiments, the target characteristic parameter of the service flow obtained through inference based on the characteristic assistance data may include a key frame interval of a service data packet corresponding to the service flow. For example, the characteristic assistance data indicates whether the constant key frame interval exists in the service flow. If the characteristic assistance data indicates that the constant key frame interval exists, the value of the key frame interval, the interval in which the key frame interval, or the like may be further obtained through inference.

In some embodiments, the target characteristic parameter of the service flow obtained through inference based on the characteristic assistance data may include whether the service data packet set (for example, the PDU set) having the association and a characteristic of a service data packet included in the service data packet set exist in the service flow. The characteristic of the service data packet may include, for example, whether the service data packets in the PDU set are of equal ranking, whether the content corresponding to the PDU set is recoverable after part of the service data packets in the PDU set are lost, and the like.

In some embodiments, if rankings of the service data packets in the service data packet set are different and the content corresponding to the service data packet set is recoverable after part of the service data packets in the service data packet set are lost, the target characteristic parameter of the service flow obtained through inference may further include: a packet loss policy of the service data packet set, and the packet loss policy may be configured for indicating to abandon transmission of a service data packet in the service data packet set during network congestion.

If rankings of service data packets in the service data packet set are different, it indicates that part of the service data packets cannot be lost. However, if part of the service data packets are lost, recovery of the service data packet set may not be affected. During network congestion, a service data packet with a low ranking may be discarded based on the packet loss policy.

If the service data packets in the service data packet set are of equal ranking, it indicates that the service data packets cannot be lost during transmission. If the packets are lost, the content corresponding to the service data packet set may be unrecoverable. In a transmission process, if part of the service data packets are lost, all service data packets in the service data packet set may be discarded.

In some embodiments, if the target characteristic parameter of the service flow may include the frame rate of the service data packet corresponding to the service flow, based on performing inferencing on the frame rate of the service data packet corresponding to the service flow, the network-side network element may count, based on a transmission timestamp of the service data packet, a transmitted volume of the service data packet in unit time; and determine, based on the transmitted volume of the service data packet in the unit time, the frame rate of the service data packet.

If the unit time may be, for example, one second, based on the transmission timestamp of the service data packet, a transmitted volume of the service data packet in one second may be counted, and the transmitted volume of the service data packet in one second is used as the frame rate of the service data packet. The unit time may be another value (such as one minute or thirty seconds). Based on the transmitted volume in the unit time being counted, the transmitted volume in the one second is calculated.

In some embodiments, if the target characteristic parameter of the service flow may include the key frame interval of the service data packet corresponding to the service flow, based on performing inferencing on the key frame interval of the service data packet corresponding to the service flow, the network-side network element may determine, based on a size change rule of the service data packet corresponding to the service flow, a target data packet with a data volume greater than a set threshold, and use an interval between adjacent target data packets as the key frame interval. Because a data packet of a key frame is large, the data packet of the key frame may be determined based on a size of the data packet, and an interval between data packets of adjacent key frames is used as the key frame interval.

In some embodiments, the network-side network element may perform, based on the characteristic assistance data, characteristic parameter inferencing through a machine learning model to obtain the target characteristic parameter. The network-side network element may train the machine learning model by using sample data, so that the machine learning model learns a prediction rule of a characteristic parameter of a service flow, to infer the characteristic parameter of the service flow through the trained machine learning model.

In some embodiments, the sample data for training the machine learning model may be characteristic assistance data of a service flow sample with a known characteristic parameter. During training, the characteristic assistance data of the service flow sample is inputted into the machine learning model for prediction, a prediction result of the machine learning model is compared with the known characteristic parameter of the service flow sample, and a model parameter of the machine learning model is adjusted based on a comparison result, so that a loss value between the prediction result of the machine learning model and the known characteristic parameter of the service flow sample meets a convergence condition. The machine learning model may be a convolutional neural network (CNN) model, a recurrent neural network (RNN) model, or the like.

FIG. 3, 330: Process a service data packet of the service flow based on the inferred target characteristic parameter.

In some embodiments, the processing a service data packet of the service flow based on the inferred target characteristic parameter may be forwarding the service data packet based on the corresponding target characteristic parameter, or may be configuring the corresponding target characteristic parameter into a corresponding network element, for example, the UPO or a base station, to allocate an appropriate transmission resource for transmitting the service data packet of the service flow.

In some embodiments, if the target characteristic parameter of the service flow includes the periodicity of the service data packet corresponding to the service flow, a semi-persistent scheduling manner or a static scheduling manner may be configured for the service flow if data volumes transmitted through the service data packet in different periodicities are the same; and a dynamic scheduling manner may be configured for the service flow if the data volumes transmitted through the service data packet in the different periodicities are different.

If the data volumes transmitted through the service data packet in the different periodicities are the same, the network-side network element (for example, an access network-side network element) may allocate a constant quantity of time-frequency resources to a terminal device during scheduling, and the scheduling manner may be selected as the semi-persistent scheduling manner or the static scheduling manner. If the data volumes transmitted through the service data packet in different periodicities are different, during transmission and scheduling, a different quantity of time-frequency resources may be scheduled based on a requirement of a service flow and a network status, or the dynamic scheduling manner may be used.

Some embodiments are described above from a perspective of a network-side network element, and some embodiments are further described below from a perspective of an application-side network element.

FIG. 4 is a flowchart of a service data packet processing method according to some embodiments. The service data packet processing method may be performed by an application-side network element, and the application-side network element is a network element at an application layer, for example, may be an application object (AO) (or sometimes referred to as an “application function” (AF) by the 3GPP, for example). Refer to FIG. 4. The service data packet processing method may include operations 410 to 430. Detailed descriptions are as follows.

410: Obtain, based on feature information of a service flow, an initial characteristic parameter of the service flow.

The initial characteristic parameter may refer to a characteristic parameter that may be obtained by the application-side network element. The initial characteristic parameter may not be complete, for example, lacks values corresponding to some characteristic parameters.

In some embodiments, the feature information of the service flow may include at least one of the following: an encoding manner configured for the service flow, service data content corresponding to the service flow, and a configuration parameter of the service flow.

The encoding manner configured for the service flow may be, for example, one of the following: advanced video coding (AVC), high efficiency video coding (HEVC), and versatile video coding (VVC).

The service data content corresponding to the service flow may be, for example, one or more of the following: audio, video, and haptic (haptic information).

The configuration parameter of the service flow may include a parameter that may affect a characteristic of a service flow, for example, a constant rate factor (CRF) or an average rate.

420: Generate, based on the obtained initial characteristic parameter, characteristic assistance data for the service flow, the characteristic assistance data including data associated with a characteristic of the service flow.

In some embodiments, the characteristic assistance data may include a part of characteristic parameters of the service flow, or may include indication information configured for determining a characteristic parameter of the service flow.

The characteristic assistance data may include whether a periodicity exists in the service flow. If the periodicity exists, the characteristic assistance data may further include a value of the periodicity or an interval in which the periodicity is located, or may further include whether data volumes transmitted in different periodicities are equal.

The characteristic assistance data may include, for example, whether a corresponding transmission rate exists in the service flow. If the transmission rate exists, the transmission rate may be a rate range, an average transmission rate, or the like.

The characteristic assistance data may include, for example, whether a constant frame rate exists in the service flow. If the constant frame rate exists, the characteristic assistance data may further include a value of a frame rate, an interval in which the frame rate is located, or the like.

The characteristic assistance data may include, for example, whether a constant key frame interval exists in the service flow. If the constant key frame interval exists, the characteristic assistance data may further include a value of the key frame interval, an interval in which the key frame interval is located, or the like.

The characteristic assistance data may include, for example, whether a service data packet set (for example, a PDU set) having an association exists in the service flow. If the PDU set exists, the characteristic assistance data may further include whether service data packets in the PDU set are of equal ranking, whether content corresponding to the PDU set is recoverable after part of the service data packets in the PDU set are lost, and the like.

430: Transmit the characteristic assistance data to a network-side network element, the characteristic assistance data being configured for assisting the network-side network element in performing characteristic parameter inferencing to obtain a target characteristic parameter of the service flow.

For a process in which the network-side network element infers the target characteristic parameter of the service flow based on the characteristic assistance data, according to some embodiments, refer to FIG. 3.

Some embodiments are described above from perspectives of a network-side network element and an application-side network element. In some embodiments, the network-side network element may determine a characteristic parameter of a service flow under assistance of the application-side network element, thereby improving accuracy of the determined characteristic parameter of the service flow, facilitating optimization of transmission of the service flow, and improving processing efficiency of the service data packet. This avoids large dependence on the application-side network element due to a fact that the characteristic parameter of the service flow is provided by the application-side network element alone, and also avoids inaccuracy of the characteristic parameter due to a fact that inferencing is performed by the network-side network element alone.

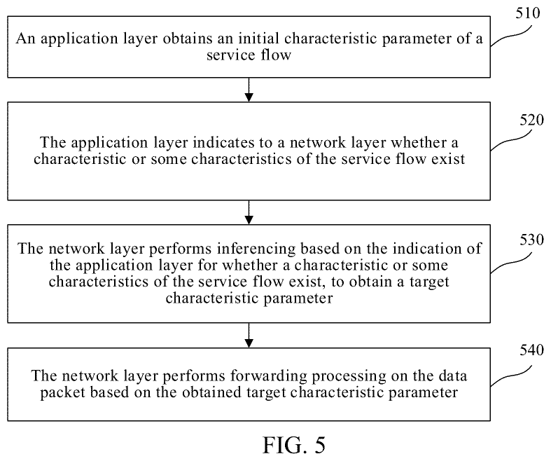

In some embodiments, an application layer (for example, an application-side network element) may provide a limited information indication for a network layer (for example, a network-side network element) based on a characteristic of a service flow such as a periodicity, a rate, a key frame interval, a frame rate, or a data packet set (a PDU set). The network layer infers, based on a part of indication characteristics indicated by the application layer, the remaining characteristics through a machine learning or artificial intelligence method, so that a complete target characteristic parameter is obtained, thereby implementing network layer processing of multimedia service data. For a processing procedure according to some embodiments, refer to FIG. 5. The procedure includes the following operations:

510: The application layer obtains an initial characteristic parameter of a service flow.

In some embodiments, the application layer may obtain the initial characteristic parameter of the service flow based on an encoding manner configured for the service flow, content or a configuration parameter of a service data packet, or the like.

The encoding manner includes but is not limited to AVC, HEVC, VVC, or the like; the content of the service data packet includes but is not limited to audio, video, haptic, and the like; and the configuration parameter includes but is not limited to a parameter that may affect the characteristic of the service flow, for example, a CRF or an average rate.

In some embodiments, a characteristic parameter of the service flow includes but is not limited to the periodicity, the rate, the key frame interval, the frame rate, a data packet set (the PDU set) characteristic, or the like; and the initial characteristic parameter may be an incomplete characteristic parameter, for example, lacks a value of the characteristic parameter.

A criterion for determining whether the periodicity exists in a data packet of the service flow may be whether the service flow generates data in a constant periodicity. Data volumes of the data may be the same or different. If the data volumes of the data are the same, a network side may allocate a constant quantity of time-frequency resources during scheduling and transmission, and a semi-persistent or even static scheduling policy may be used. If the data volumes of the data are different, the network side may schedule, based on a requirement of the service flow, a different quantity of time-frequency resources during scheduling and transmission, and it is relatively difficult to use the semi-persistent or static scheduling policy.

The rate in the initial characteristic parameter of the service flow refers to whether a rate characteristic exists in the data packet of the service flow, and if the rate characteristic exists, the rate may be a rate range or an average rate. The average rate is an attribute of some encoder stream-pushing software, and the attribute may facilitate configuration and monitoring of a quality of service (QoS) policy by the network layer.

The frame rate in the initial characteristic parameter of the service flow refers to whether a constant frame rate exists in the service flow. If the constant frame rate exists, the frame rate may be a value, change range information of the frame rate (for example, an interval in which the frame rate is located), or the like.

The key frame interval in the initial characteristic parameter of the service flow refers to whether a constant key frame interval exists in the service flow. If the constant key frame interval exists, the key frame interval may be a value of the key frame interval, an interval in which the key frame interval is located, or the like.

The data packet set (the PDU SET) in the initial characteristic parameter of the service flow refers to whether a service data packet set (for example, a PDU set) having an association exists in the service flow. If the PDU set exists, the PDU set may be whether service data packets in the PDU set are of equal ranking, whether content corresponding to the PDU set is recoverable after part of the service data packet in the PDU set are lost, and the like.

520: The application layer indicates to the network layer whether a characteristic or some characteristics of the service flow exist.

In some embodiments, the application layer may indicate, to the network layer, one or more of the following characteristics of the service flow: the periodicity, the rate, the key frame interval, the frame rate, and the data packet set (the PDU set) characteristic.

The application layer may indicate to the network layer whether the periodicity exists in the data packet of the service flow. If an application side does not notify the network layer of a periodicity value, the network layer may obtain the periodicity value through an artificial intelligence or machine learning method.

The application layer may indicate to the network layer whether the rate characteristic exists in the data packet of the service flow. If the application side does not notify the network layer of a rate value, the network layer may obtain the rate value through the artificial intelligence or machine learning method.

The application layer may indicate to the network layer whether a constant or relatively constant key frame interval/frame rate exists in the data packet of the service flow. If the application side does not notify the network layer of a key frame interval/frame rate, the network layer may obtain the key frame interval/frame rate through the artificial intelligence or machine learning method.

The application layer may indicate to the network layer whether the data packet set characteristic exists in the data packet of the service flow. If the application side does not notify the network layer of a data packet set characteristic, the network layer may obtain the data packet set characteristic through the artificial intelligence or machine learning method.

530: The network layer performs inferencing based on the indication of the application layer for whether a characteristic or some characteristics of the service flow exist to obtain a target characteristic parameter.

In some embodiments, the network layer may learn and infer the periodicity of the service flow based on the indication provided by the application layer for whether the periodicity exists. The periodicity of the service flow may include a periodicity of constant data volumes and a periodicity of variable data volumes.

In some embodiments, the network layer may infer the rate or the rate range based on the indication provided by the application layer for whether the constant rate exists or the rate is within a range.

In some embodiments, the network layer may obtain the key frame interval/frame rate based on the indication provided by the application layer for whether the constant or relatively constant key frame interval/frame rate exists.

Inferencing of the frame rate may be detected based on a data packet rule. For example, for a service data packet based on a real-time transport protocol (RTP), a transmitted volume of the service data packet in unit time may be counted through a timestamp of a transmit end, and the frame rate of the service data packet is determined based on the transmitted volume of the service data packet in the unit time.

The network layer may also determine the key frame interval based on a size change rule of the data packet. For example, each instantaneous decoding refresh (IDR) frame may have a large data packet during generation, for example, a maximum packet under a limitation of a maximum transmission unit (MTU). An interval between two large data packets may be used as the key frame interval.

540: The network layer performs forwarding processing on the data packet based on the obtained target characteristic parameter.

In some embodiments, based on processing the data packet, the network layer may process the data packet based on the PDU set characteristic, or may process the data packet by associating the PDU set characteristic with a parameter of the service data packet, for example, the periodicity, the rate, or the frame rate.

When processing the data packet based on the PDU set characteristic, if the service data packets in the PDU set are of equal ranking, it indicates that the service data packets cannot be lost during transmission, and the content corresponding to the PDU set may be unrecoverable if the service data packets are lost. If part of the service data packets are lost, all service data packets in the service data packet set may be discarded. If rankings of the service data packets in the PDU set are different, it indicates that part of the service data packets cannot be lost. However, if part of the service data packets are lost, recovery of the PDU set may not be affected. During network congestion, a service data packet with a low ranking may be discarded, to reduce, without affecting recovery of the service data packet set, impact caused by network congestion.

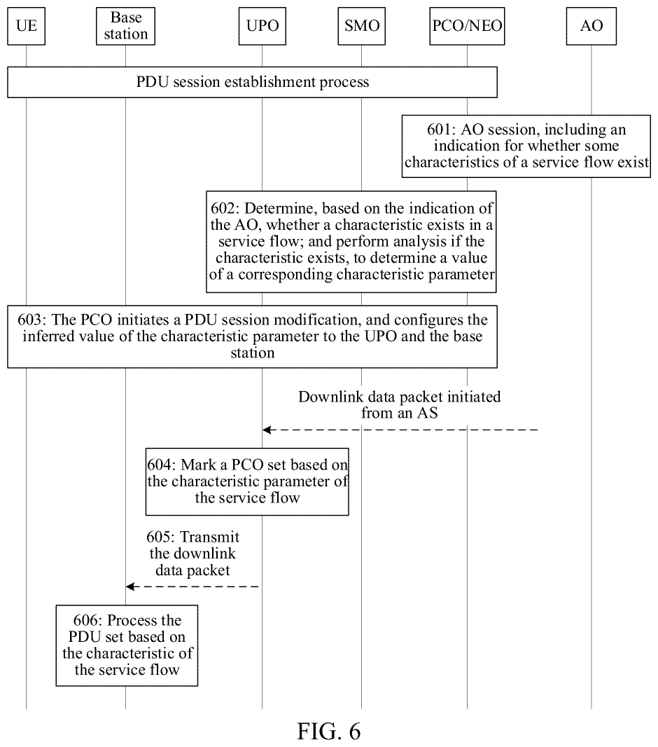

As shown in FIG. 6, a service data packet processing method, according to some embodiments, includes the following operations.

601: Based on a PDU session being established, an AO initiates an AO session with a QoS, including an indication for whether some characteristics of a service flow exist.

A PDU session establishment process may relate to a session management object (SMO) (or sometimes referred to as a “session management function” (SMF) by the 3GPP, for example).

602: A PCO determines, based on the indication of the AO, whether a characteristic exists in the service flow; and performs analysis if the characteristic exists, to determine a value of a corresponding characteristic parameter.

The AO may provide indication information for the PCO in a control plane (and the indication information may be directly transmitted to the PCO, or may be first sent to a network exposure object (NEO) (or sometimes referred to as a “network exposure function” (NEF) by the 3GPP, for example) and then forwarded to the PCO by the NEO), to indicate a characteristic or some characteristics of the service flow. When performing analysis to determine the value of the characteristic parameter, the PCO may perform inferencing and analysis by using a parameter provided by a network element, for example, a UPO or a network data analyzer object (NWDAO) (or sometimes referred to as a “network data analyzer function” (NWDAF) by the 3GPP, for example).

603: The PCO initiates a PDU session modification, and configures the inferred value of the characteristic parameter to the UPO and a base station.

604: Based on the PCO configuring the inferred value of the characteristic parameter to the UPO and the base station, if the UPO receives a downlink data packet initiated from an application server (AS), a PCO set is identified based on the characteristic parameter of the service flow.

For example, if a characteristic of the service flow indicates that a PDU set characteristic exists in a service data packet, service data packets belonging to a same PDU set may be identified. A corresponding parameter may be added to user plane header information of the service data packet to indicate a relationship between service data packets, so that the service data packet belonging to the same PDU set may be identified through the user plane header information.

605: The UPO transmits the downlink data packet to the base station.

606: The base station processes the PDU set based on the characteristic of the service flow.

In some embodiments, based on the characteristic of the service flow, if data volumes transmitted through the service data packet in different periodicities are the same, the base station may allocate a constant quantity of time-frequency resources to a terminal device during scheduling, and the scheduling manner may be selected as a semi-persistent scheduling manner or a static scheduling manner. If the data volumes transmitted through the service data packet in the different periodicities are different, during transmission and scheduling, the base station may schedule a different quantity of time-frequency resources based on a requirement of the service flow and a network status, or a dynamic scheduling manner may be used.

In some embodiments, based on the characteristic of the service flow, if rankings of service data packets in the PDU set are different and content corresponding to the service data packet set is recoverable after part of the service data packets in the PDU set are lost, the base station may discard a service data packet with a low ranking during network congestion.

If the service data packets in the PDU set are of equal ranking, it indicates that the service data packets cannot be lost during transmission. If the packets are lost, the content corresponding to the service data packet set may be unrecoverable. In a transmission process, if part of the service data packets are lost, the base station may discard all service data packets in the service data packet set.

In some embodiments, a network-side network element may determine a characteristic parameter of a service flow under assistance of an application-side network element, thereby improving accuracy of the determined characteristic parameter of the service flow, facilitating optimization of transmission of the service flow, and improving processing efficiency of the service data packet. This avoids large dependence on the application-side network element due to a fact that the characteristic parameter of the service flow is provided by the application-side network element alone, and also avoids inaccuracy of the characteristic parameter due to a fact that inferencing is performed by the network-side network element alone.

The following describes an apparatus according to some embodiments, and the apparatus embodiments may be configured for performing the service data packet processing method according to some embodiments.

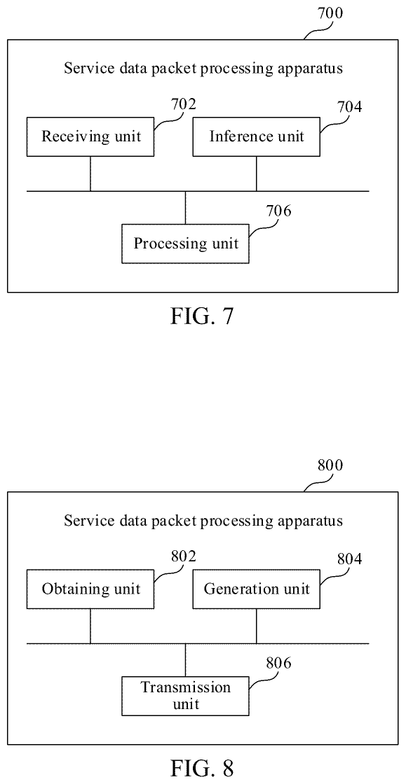

FIG. 7 is a block diagram of a service data packet processing apparatus according to some embodiments. The processing apparatus may be arranged in a network-side network element, and the network-side network element may be, for example, a PCO.

A service data packet processing apparatus 700, according to some embodiments, may include a receiving unit 702, an inference unit 704, and a processing unit 706.

The receiving unit 702 may be configured to receive characteristic assistance data transmitted by an application-side network element for a service flow, the characteristic assistance data including data associated with a characteristic of the service flow; the inference unit 704 may be configured to perform characteristic parameter inferencing based on the characteristic assistance data to obtain a target characteristic parameter of the service flow; and the processing unit 706 may be configured to process a service data packet of the service flow based on the inferred target characteristic parameter.

In some embodiments, the target characteristic parameter of the service flow obtained through inference based on the characteristic assistance data includes at least one of the following:
a periodicity of the service data packet corresponding to the service flow;
a transmission rate of the service data packet corresponding to the service flow, and the transmission rate may include at least one of a rate range and an average rate;
a frame rate of the service data packet corresponding to the service flow;
a key frame interval of the service data packet corresponding to the service flow; and
whether a service data packet set having an association and a characteristic of a service data packet included in the service data packet set exist in the service flow.

In some embodiments, the characteristic of the service data packet included in the service data packet set includes at least one of the following: whether service data packets in the service data packet set are of equal ranking, and whether content corresponding to the service data packet set is recoverable after part of the service data packets in the service data packet set are lost.

In some embodiments, if rankings of the service data packets in the service data packet set are different and the content corresponding to the service data packet set is recoverable after part of the service data packets in the service data packet set are lost, the target characteristic parameter of the service flow further includes:
a packet loss policy of the service data packet set, and the packet loss policy may be configured for indicating to abandon transmission of a service data packet in the service data packet set during network congestion.

In some embodiments, the target characteristic parameter of the service flow obtained through inference based on the characteristic assistance data includes a frame rate of the service data packet corresponding to the service flow.

The inference unit 704 may be configured to count, based on a transmission timestamp of the service data packet, a transmitted volume of the service data packet in unit time; and determine, based on the transmitted volume of the service data packet in the unit time, the frame rate of the service data packet.

In some embodiments, the target characteristic parameter of the service flow obtained through inference based on the characteristic assistance data includes a key frame interval of the service data packet corresponding to the service flow.

The inference unit 704 may be configured to |determine, based on a size change rule of the service data packet corresponding to the service flow, a target data packet with a data volume greater than a set threshold; and use an interval between adjacent target data packets as the key frame interval.

In some embodiments, a characteristic parameter of the service flow includes a periodicity of the service data packet corresponding to the service flow. The processing unit 706 is further configured to configure a semi-static scheduling manner or a static scheduling manner for the service flow if data volumes transmitted through the service data packet in different periodicities are the same; and configure a dynamic scheduling manner for the service flow if the data volumes transmitted through the service data packet in the different periodicities are different.

In some embodiments, the inference unit 704 may be configured to perform, based on the characteristic assistance data, characteristic parameter inferencing through a machine learning model to obtain the target characteristic parameter of the service flow.

FIG. 8 is a block diagram of a service data packet processing apparatus according to some embodiments. The processing apparatus may be arranged in an application-side network element, for example, may be arranged in an AO.

Refer to FIG. 8. A service data packet processing apparatus 800 according to some embodiments includes an obtaining unit 802, a generation unit 804, and a transmission unit 806.

The obtaining unit 802 may be configured to obtain, based on feature information of a service flow, an initial characteristic parameter of the service flow; the generation unit 804 may be configured to generate, based on the obtained initial characteristic parameter, characteristic assistance data for the service flow, the characteristic assistance data including data associated with a characteristic of the service flow; and the transmission unit 806 may be configured to transmit the characteristic assistance data to a network-side network element, the characteristic assistance data being configured for assisting the network-side network element in performing characteristic parameter inferencing to obtain a target characteristic parameter of the service flow.

In some embodiments, the feature information of the service flow includes at least one of the following: an encoding manner configured for the service flow, service data content corresponding to the service flow, and a configuration parameter of the service flow.

In some embodiments, the characteristic assistance data includes a part of characteristic parameters of the service flow.

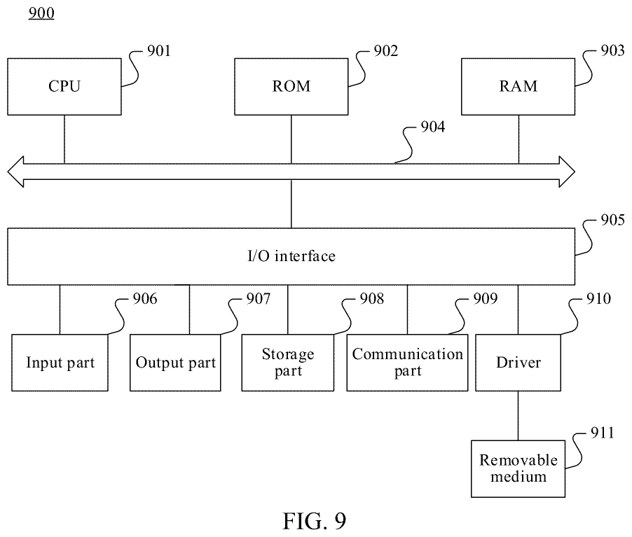

FIG. 9 is a schematic structural diagram of a computer system of an electronic device according to some embodiments.

A computer system 900 of the electronic device, according to some embodiments, is shown in FIG. 9, but the disclosure is not limited thereto.

As shown in FIG. 9, the computer system 900 includes a central processing unit (CPU) 901, which may perform various suitable actions and processing based on a program stored in a read-only memory (ROM) 902 or a program loaded from a storage part 908 into a random access memory (RAM) 903, for example, perform the method according to some embodiments. The RAM 903 further stores various programs and data used for system operations. The CPU 901, the ROM 902, and the RAM 903 are connected to each other through a bus 904. An input/output (I/O) interface 905 is also connected to the bus 904.

The following components are connected to the I/O interface 905: an input part 906 including a keyboard, a mouse, or the like; an output part 907 including a cathode ray tube (CRT), a liquid crystal display (LCD), a speaker, or the like; a storage part 908 including a hard disk, or the like; and a communication part 909 including a network interface card such as a local area network (LAN) card or a modem. The communication part 909 performs communication processing by using a network such as the Internet. A driver 910 may also be connected to the I/O interface 905. A removable medium 911, such as a magnetic disk, an optical disc, a magneto-optical disk, or a semiconductor memory, may be installed on the driver 910, and a computer program may read from the removable medium 911 installed into the storage part 908.

The processes described above may be implemented as computer software programs. For example, some embodiments includes a computer program product. The computer program product includes a computer program stored in a computer-readable medium. The computer program includes a computer program configured to execute the method shown in the flowchart. In some embodiments, the computer program may be downloaded and installed from a network through the communication part 909, and/or installed from the removable medium 911. When the computer program is executed by the CPU 901, the various functions defined in the system in some embodiments are executed.

The computer-readable medium, according to some embodiments, may be a computer-readable signal medium or a computer-readable storage medium or any combination of the two. The computer-readable storage medium may be, for example, but is not limited to, an electric, magnetic, optical, electromagnetic, infrared, or semi-conductive system, apparatus, or component, or any combination of the above. An example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. The computer-readable storage medium may be any tangible medium including or storing a program, and the program may be used by or used in combination with an instruction execution system, an apparatus, or a device. The computer-readable signal medium may include a data signal transmitted in a baseband or as part of a carrier, and stores a computer-readable computer program. A data signal propagated in such a way may use a plurality of forms, including, but not limited to, an electromagnetic signal, an optical signal, or any appropriate combination thereof. The computer-readable signal medium may be further any computer-readable medium in addition to a computer-readable storage medium. The computer-readable medium may transmit, propagate, or transmit a program that may be used by or used in conjunction with an instruction execution system, an apparatus, or a device. The computer program included in the computer-readable medium may be transmitted by using any suitable medium, including but not limited to: a wireless medium, a wire, or the like, or any suitable combination thereof.

The flowcharts and block diagrams in the accompanying drawings illustrate possible system architectures, functions and operations that may be implemented by a system, a method, and a computer program product according to some embodiments. Each box in a flowchart or a block diagram may represent a module, a program segment, or a part of code. The module, the program segment, or the part of code includes one or more executable instructions used for implementing specified logic functions. In some implementations used as substitutes, functions annotated in boxes may occur in a sequence different from that annotated in an accompanying drawing. For example, two boxes shown in succession may be performed in parallel, and the two boxes may be performed in a reverse sequence. This may be determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer program.

According to some embodiments, each module or unit may exist respectively or be combined into one or more modules or units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, and the instructions of each unit may be executable by a processor to thereby cause the processor to perform the respective operations of the corresponding unit.

The non-transitory computer-readable medium may be included in the electronic device described in some embodiments, or may exist alone and is not disposed in the electronic device. The computer-readable medium carries one or more computer programs, the one or more computer programs, when executed by the electronic device, causing the electronic device to implement the method according to some embodiments.

According to the foregoing descriptions, a person skilled in the art may readily understand that the exemplary implementations described herein may be implemented by using software, or may be implemented by combining software and hardware. The technical solutions of some embodiments may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A service data packet processing method, performed by a network-side network element, the method comprising:
receiving characteristic assistance data transmitted by an application-side network element for a service flow;
performing characteristic parameter inferencing based on the characteristic assistance data to obtain a target characteristic parameter of the service flow; and
processing a first service data packet of the service flow based on the obtained target characteristic parameter,
wherein the characteristic assistance data includes data associated with a first characteristic of the service flow.

2. The service data packet processing method according to claim 1, wherein the target characteristic parameter includes at least one of:
a periodicity of the first service data packet,
a transmission rate of the first service data packet, wherein the transmission rate includes at least one of a rate range or an average rate,
a frame rate of the first service data packet,
a key frame interval of the first service data packet, or
a first value indicating whether a service data packet set exists in the service flow, wherein the service data packet set includes an association and a second characteristic of a second service data packet.

3. The service data packet processing method according to claim 2, wherein the second characteristic includes at least one of:
a second value indicating whether a plurality of service data packets of the service data packet set are of equal ranking, or
a third value indicating whether content of the service data packet set is recoverable based on one or more of the plurality of service data packets being lost.

4. The service data packet processing method according to claim 3, wherein the target characteristic parameter further includes a packet loss policy of the service data packet set based on:
one or more rankings of the plurality of service data packets being different, and
the content of the service data packet set being recoverable based on the one or more of the plurality of service data packets, and
wherein the packet loss policy indicates whether to abandon transmission of a third service data packet in the service data packet set during network congestion.

5. The service data packet processing method according to claim 1, wherein the target characteristic parameter of the service flow includes a frame rate of the first service data packet, and
wherein the performing characteristic parameter inferencing comprises:
counting a transmitted volume of the first service data packet in unit time based on a transmission timestamp of the first service data packet; and
determining the frame rate of the first service data packet based on the transmitted volume of the first service data packet in the unit time.

6. The service data packet processing method according to claim 1, wherein the target characteristic parameter of the service flow includes a key frame interval of the first service data packet,
wherein the performing characteristic parameter inferencing comprises determining a target data packet with a data volume greater than a set threshold based on a size change rule of the first service data packet, and
wherein the key frame interval is based on an interval between adjacent target data packets.

7. The service data packet processing method according to claim 1, wherein the target characteristic parameter of the service flow includes a periodicity of the first service data packet, and the method further comprises:
determining a semi-persistent schedule or a static schedule for the service flow based on a plurality of data volumes transmitted through the first service data packet in different periodicities being the same; and
determining a dynamic schedule for the service flow based on the plurality of data volumes being different.

8. The service data packet processing method according to claim 1, wherein the performing characteristic parameter inferencing is performed based on a machine learning model.

9. A service data packet processing apparatus of a network-side network element, comprising:
at least one memory configured to store program code; and
at least one processor configured to read the program code and operate as instructed by the program code, the program code comprising:
receiving code configured to cause at least one of the at least one processor to receive characteristic assistance data transmitted by an application-side network element for a service flow;
inference code configured to cause at least one of the at least one processor to perform characteristic parameter inferencing based on the characteristic assistance data to obtain a target characteristic parameter of the service flow; and
processing code configured to cause at least one of the at least one processor to process a first service data packet of the service flow based on the obtained target characteristic parameter,
wherein the characteristic assistance data comprises data associated with a first characteristic of the service flow.

10. The service data packet processing apparatus according to claim 9, wherein the target characteristic parameter comprises at least one of:
a periodicity of the first service data packet;
a transmission rate of the first service data packet, wherein the transmission rate comprises at least one of a rate range or an average rate;
a frame rate of the first service data packet;
a key frame interval of the first service data packet; or
a first value indicating whether a service data packet set exists in the service flow, wherein the service data packet set comprises an association and a second characteristic of a second service data packet.

11. The service data packet processing apparatus according to claim 10, wherein the second characteristic comprises at least one of:
a second value indicating whether a plurality of service data packets of the service data packet set are of equal ranking; or
a third value indicating whether content of the service data packet set is recoverable based on one or more of the plurality of service data packets being lost.

12. The service data packet processing apparatus according to claim 11, wherein the target characteristic parameter further comprises a packet loss policy of the service data packet set based on:
one or more rankings of the plurality of service data packets being different, and
the content of the service data packet set being recoverable based on the one or more of the plurality of service data packets, and
wherein the packet loss policy indicates whether to abandon transmission of a third service data packet in the service data packet set during network congestion.

13. The service data packet processing apparatus according to claim 9, wherein the target characteristic parameter of the service flow comprises a frame rate of the first service data packet, and
wherein the inference code is configured to cause at least one of the at least one processor to:
count a transmitted volume of the first service data packet in unit time based on a transmission timestamp of the first service data packet; and
determine the frame rate of the first service data packet based on the transmitted volume of the first service data packet in the unit time.

14. The service data packet processing apparatus according to claim 9, wherein the target characteristic parameter of the service flow comprises a key frame interval of the first service data packet,
wherein the inference code is configured to cause at least one of the at least one processor to determine a target data packet with a data volume greater than a set threshold based on a size change rule of the first service data packet, and
wherein the key frame interval is based on an interval between adjacent target data packets.

15. The service data packet processing apparatus according to claim 9, wherein the target characteristic parameter of the service flow comprises a periodicity of the first service data packet, and the program code further comprises scheduling code configured to cause at least one of the at least one processor to:
determine a semi-persistent schedule or a static schedule for the service flow based on a plurality of data volumes transmitted through the first service data packet in different periodicities being the same; and
determine a dynamic schedule for the service flow based on the plurality of data volumes being different.

16. The service data packet processing apparatus according to claim 9, wherein the inference code is configured to cause at least one of the at least one processor to perform the characteristic parameter inferencing based on a machine learning model.

17. A non-transitory computer-readable medium storing computer code which, when executed by at least one processor, causes the at least one processor to at least:
receive characteristic assistance data transmitted by an application-side network element for a service flow;
perform characteristic parameter inferencing based on the characteristic assistance data to obtain a target characteristic parameter of the service flow; and
process a first service data packet of the service flow based on the obtained target characteristic parameter,
wherein the characteristic assistance data comprises data associated with a first characteristic of the service flow.

18. The non-transitory computer-readable medium according to claim 17, wherein the target characteristic parameter comprises at least one of:
a periodicity of the first service data packet,
a transmission rate of the first service data packet, wherein the transmission rate comprises at least one of a rate range or an average rate,
a frame rate of the first service data packet,
a key frame interval of the first service data packet, or
a first value indicating whether a service data packet set exists in the service flow,
wherein the service data packet set comprises an association and a second characteristic of a second service data packet.

19. The non-transitory computer-readable medium according to claim 18, wherein the second characteristic comprises at least one of:
a second value indicating whether a plurality of service data packets of the service data packet set are of equal ranking, or
a third value indicating whether content of the service data packet set is recoverable based on one or more of the plurality of service data packets being lost.

20. The non-transitory computer-readable medium according to claim 19, wherein the target characteristic parameter further comprises a packet loss policy of the service data packet set based on:
one or more rankings of the plurality of service data packets being different, and
the content of the service data packet set being recoverable based on the one or more of the plurality of service data packets, and
wherein the packet loss policy indicates whether to abandon transmission of a third service data packet in the service data packet set during network congestion.
